(19) United States
(12) Patent Application Publication
(10) Pub. No.: US 2025/0023083 A1
(43) Pub. Date: Jan. 16, 2025

(54) SYSTEMS AND METHODS FOR MECHANICAL STRENGTHENING AND ALIGNMENT OF FUEL CELL STACK ASSEMBLIES

(71) Applicant: HYDROGENICS CORPORATION, Mississauga (CA)

(72) Inventors: Hong CAO, Burnaby (CA); Rainey Yu WANG, Richmond Hill (CA); Nathaniel Ian JOOS, Toronto (CA)

(21) Appl. No.: 18/680,963

(22) Filed: May 31, 2024

Related U.S. Application Data
(60) Provisional application No. 63/507,240, filed on Jun. 9, 2023.

(51) Int. Cl. H01M 8/248; H01M 8/0247; H01M 8/2404

(52) U.S. Cl. CPC H01M 8/248; H01M 8/0247; H01M 8/2404

(57) ABSTRACT

A fuel cell stack includes a fuel cell including a bipolar plate sheet. The bipolar plate sheet includes an outer sheet edge having a first longitudinal edge and a first transverse edge, a first surface, and a first load-bearing extension arranged on the first longitudinal edge or the first transverse edge. The first load-bearing extension is configured to engage with an alignment bar or a support bar of a fuel cell stack assembling apparatus within which the fuel cell stack is compressed for assembly such that, during compression of the fuel cell stack, the first load-bearing extension engages the alignment bar or the support bar so as to transfer force loads from the alignment bar or the support bar away from the first outer sheet edge and toward a central area of the first bipolar plate sheet.

### CROSS-REFERENCE TO RELATED APPLICATIONS

This nonprovisional application claims the benefit and priority, under 35 U.S.C. § 119 (e) and any other applicable laws or statues, to U.S. Provisional Patent Application Ser. No. 63/507,240 filed on Jun. 9, 2023, the entire disclosure of which is hereby expressly incorporated herein by reference.

### TECHNICAL FIELD

The present disclosure generally relates to fuel cell stack assemblies, in particular the assembly and alignment of fuel cells within a fuel cell stack assembly.

### BACKGROUND

A fuel cell is one of many repeating units of a fuel cell stack that may provide power or energy for personal, mobility, and/or industrial use. An exemplary fuel cell is comprised of many fuel cell assemblies compressed and bound into a fuel cell stack. A fuel cell is a multi-component assembly that often comprises a membrane electrode assembly (MEA) at the center, a gas diffusion layer (GDL) on either side of the membrane electrode assembly (MEA), and a bipolar plate (BPP) on either side of the gas diffusion layer (GDL). The membrane electrode assembly (MEA) is the component that enables electrochemical reactions in the fuel cell and/or the fuel cell stack. In most mobility applications, reactants supplied to the fuel cell are pure hydrogen for the anode and an oxidant for the cathode.

When fuel cells are compressed together to form a fuel cell stack, alignment issues may arise. Mechanisms for maintaining alignment during compression may also cause deformations in the sides of the bipolar plates (BPP), thus compromising the structural integrity of the bipolar plates (BPP). Accordingly, systems and methods for improving alignment of fuel cells in a fuel cell stack during compression of the stack while also reducing or eliminating mechanical deformations would be beneficial.

### SUMMARY

According to a first aspect of the present disclosure, a fuel cell stack includes a first fuel cell including a first bipolar plate having a first bipolar plate sheet. The first bipolar plate sheet includes a first outer sheet edge extending around a perimeter of the first bipolar plate sheet. The first outer sheet edge includes a first longitudinal edge and a first transverse edge. The first bipolar plate sheet includes a first surface including a plurality of channels defining an active region of the first bipolar plate sheet. The first longitudinal edge and the first transverse edge are located outside of the active region. The first bipolar plate sheet includes a first load-bearing extension.

The first load-bearing extension is arranged on at least one of the first longitudinal edge or the first transverse edge of the first outer sheet edge. The first load-bearing extension is configured to engage with an alignment bar or a support bar of a fuel cell stack assembling apparatus within which the fuel cell stack is compressed for assembly such that, during compression of the fuel cell stack, the first load-bearing extension engages the alignment bar or the support bar so as to transfer force loads from the alignment bar or the support bar away from the first outer sheet edge and toward a central area of the first bipolar plate sheet.

In some embodiments, the first bipolar plate sheet may include a first sheet body including the first outer sheet edge and the first surface. In some embodiments, the first load-bearing extension may be integrally formed with the first sheet body. In some embodiments, the first load-bearing extension may include a generally planar top extension body having a first extension longitudinal edge that is adjoined to the first longitudinal edge or the first transverse edge of the first outer sheet edge of the first bipolar plate sheet.

In some embodiments, the top extension body of the first load-bearing extension may further include a first extension transverse edge and a second extension traverse edge spaced apart from and parallel with the first extension transverse edge. In some embodiments, each of the first extension transverse edge and the second extension transverse edge may extend away from the first extension longitudinal edge. In some embodiments, the top extension body of the first load-bearing extension may further include a second extension longitudinal edge spaced apart and parallel to the first extension longitudinal edge. In some embodiments, the second extension longitudinal edge may be configured to engage the alignment bar or the support bar.

In some embodiments, the first bipolar plate may further include a second bipolar plate sheet arranged on a second surface of the first bipolar plate sheet opposite the first surface. In some embodiments, the first load-bearing extension may further include a bottom extension body arranged on a bottom side of the top extension body and may have a third extension longitudinal edge that is adjoined to a longitudinal edge of the second bipolar plate sheet. In some embodiments, the top and bottom extension bodies may be planar and together form the first load-bearing extension.

In some embodiments, the top extension body may include at least one top ridge formed thereon. In some embodiments, the bottom extension body may include at least one bottom ridge formed thereon. In some embodiments, the at least one top ridge and the at least one bottom ridge may be raised in opposing directions so as to form a ridge channel between the at least one top ridge and the at least one bottom ridge. In some embodiments, the at least one top ridge and the at least one bottom ridge may each extend from the first extension longitudinal edge to the second extension longitudinal edge.

In some embodiments, the first bipolar plate sheet may further include a second load-bearing extension adjoined to the first sheet body on the first longitudinal edge or the first transverse edge and spaced apart from the first load-bearing extension. In some embodiments, the first outer sheet edge of the first bipolar sheet may further include a second longitudinal edge opposite and parallel to the first longitudinal edge. In some embodiments, the first bipolar plate sheet may further include a second load-bearing extension adjoined to the first sheet body on the second longitudinal edge.

In some embodiments, the fuel cell stack may further include a second fuel cell including a second bipolar plate having a second bipolar plate sheet. In some embodiments, the second bipolar plate sheet may include a second outer sheet edge extending around a perimeter of the second bipolar plate sheet. In some embodiments, the second outer sheet edge may include a third longitudinal edge and a third transverse edge. In some embodiments, the second bipolar plate sheet may include a second surface including a plurality of channels defining an active region of the second bipolar plate sheet. In some embodiments, the third longitudinal edge and the third transverse edge may be located outside of the active region. In some embodiments, the second bipolar plate sheet may include a second load-bearing extension.

In some embodiments, the second load-bearing extension may be arranged on at least one of the third longitudinal edge or the third transverse edge of the second outer sheet edge. In some embodiments, the second load-bearing extension may be configured to engage with the alignment bar or the support bar of the fuel cell stack assembling apparatus such that, during compression of the fuel cell stack, the second load-bearing extension engages the alignment bar or the support bar so as to transfer force loads from the alignment bar or the support bar away from the second outer sheet edge and toward a central area of the second bipolar plate sheet. In some embodiments, the second load-bearing extension may be aligned with the first load-bearing extension of the first bipolar plate sheet such that engagement of the alignment bar or the support bar with the first and second load-bearing extensions aligns the first and second fuel cells with each other.

In some embodiments, the second load-bearing extension may include a generally planar top extension body having a third extension longitudinal edge that is adjoined to the third longitudinal edge of the second outer sheet edge of the second bipolar plate sheet. In some embodiments, the top extension body of the second load-bearing extension may further include a fourth extension longitudinal edge spaced apart and parallel to the third extension longitudinal edge. In some embodiments, the fourth extension longitudinal edge of the second load-bearing extension may be aligned with the second extension longitudinal edge of the first load-bearing extension.

According to a further aspect of the present disclosure, a fuel cell stack assembly system includes a plurality of fuel cells including a first fuel cell including a first bipolar plate having a first bipolar plate sheet. The first bipolar plate sheet includes a first outer sheet edge extending around a perimeter of the first bipolar plate sheet, a first surface, and a first load-bearing extension arranged on the first outer sheet edge. The fuel cell stack assembly system further comprises a fuel cell stack assembling apparatus including a stack-receiving space for receiving the plurality of fuel cells in a stacked arrangement so as to define a fuel cell stack, a press assembly configured to compress the plurality of fuel cells together, and at least one of an alignment bar or a support bar arranged outside of and adjacent to the plurality of fuel cells arranged in the stack-receiving space and configured to contact the plurality of fuel cells so as to maintain alignment of the plurality of fuel cells within the stack-receiving space. The first load-bearing extension is configured to engage with the alignment bar or the support bar of the fuel cell stack assembling apparatus such that, during compression of the fuel cell stack by the press assembly, the first load-bearing extension engages the alignment bar or the support bar so as to transfer force loads from the alignment bar or the support bar away from the first outer sheet edge and toward a central area of the first bipolar plate sheet and so as to maintain alignment of the plurality of fuel cells.

In some embodiments, the plurality of fuel cells may further include a second fuel cell including a second bipolar plate having a second bipolar plate sheet. In some embodiments, the second bipolar plate sheet may include a second outer sheet edge extending around a perimeter of the second bipolar plate sheet, a second surface, and a second load-bearing extension arranged on the second outer sheet edge. In some embodiments, the second load-bearing extension may be configured to engage with the alignment bar or the support bar of the fuel cell stack assembling apparatus such that, during compression of the fuel cell stack by the press assembly, the second load-bearing extension engages the alignment bar or the support bar so as to transfer force loads from the alignment bar or the support bar away from the second outer sheet edge and toward a central area of the second bipolar plate sheet.

In some embodiments, the second load-bearing extension of the second fuel cell may be aligned with the first load-bearing extension of the first fuel cell in the stacked arrangement such that engagement of the alignment bar or the support bar with the first and second load-bearing extensions aligns the first and second fuel cells with each other.

In some embodiments, each fuel cell of the plurality of fuel cells may include a respective bipolar plate having a respective bipolar plate sheet. In some embodiments, each respective bipolar plate sheet may include a respective outer sheet edge extending around a perimeter of the respective bipolar plate sheet, a respective surface, and a respective load-bearing extension arranged on the respective outer sheet edge. In some embodiments, each respective load-bearing extension may be configured to engage with the alignment bar or the support bar of the fuel cell stack assembling apparatus such that, during compression of the fuel cell stack by the press assembly, each respective load-bearing extension engages the alignment bar or the support bar so as to transfer force loads from the alignment bar or the support bar away from each respective outer sheet edge and toward a central area of the respective bipolar plate sheet and so as to maintain alignment of the plurality of fuel cells.

In some embodiments, the first bipolar plate sheet may include a first sheet body including the first outer sheet edge and the first surface. In some embodiments, the first load-bearing extension may be integrally formed with the first sheet body. In some embodiments, the first load-bearing extension may include a generally planar top extension body having a first extension longitudinal edge that is adjoined to the first longitudinal edge or the first transverse edge of the first outer sheet edge of the first bipolar plate sheet. In some embodiments, the top extension body of the first load-bearing extension may further include a first extension transverse edge and a second extension traverse edge spaced apart from and parallel with the first extension transverse edge that each extend away from the first extension longitudinal edge. In some embodiments, the top extension body of the first load-bearing extension may further include a second extension longitudinal edge spaced apart and parallel to the first extension longitudinal edge. In some embodiments, the second extension longitudinal edge may be configured to engage the alignment bar or the support bar.

According to a further aspect of the present disclosure, a method of forming a fuel cell stack includes arranging a plurality of fuel cells in a stacked arrangement within a stack-receiving space of a fuel cell stack assembling apparatus. Each fuel cell of the plurality of fuel cells includes a bipolar plate having a bipolar plate sheet. The bipolar plate sheet includes an outer sheet edge extending around a perimeter of the bipolar plate sheet, a first surface, and a first load-bearing extension arranged on the outer sheet edge. The method further includes aligning each fuel cell of the plurality of fuel cells with each other via alignment of the outer sheet edges and the first load-bearing extensions of each fuel cell. The method further includes providing at least one of an alignment bar or a support bar outside of and adjacent to the plurality of fuel cells arranged in the stack-receiving space and configuring the at least one of the alignment bar or the support bar to contact at least one first load-bearing extension of a fuel cell of the plurality of fuel cells in order to maintain alignment of the plurality of fuel cells within the stack-receiving space. The method further comprises compressing each fuel cell of the plurality of fuel cells together via a press assembly of the fuel cell stack assembling apparatus such that the at least one first load-bearing extension engages with the alignment bar or the support bar of the fuel cell stack assembling apparatus so as to transfer force loads from the alignment bar or the support bar away from the outer sheet edge and toward a central area of the respective bipolar plate sheet and so as to maintain alignment of the plurality of fuel cells.

In some embodiments, the bipolar plate sheet of each fuel cell may further include a first through-hole extending through the bipolar plate sheet spaced apart from the first outer sheet edge. In some embodiments, the first through-hole may include a further load-bearing extension extending inwardly from an inner circumferential edge of the first through-hole. In some embodiments, the further load-bearing extension may be configured to engage with a further alignment rod of the fuel cell stack assembling apparatus such that, during compression of the fuel cell stack, the further load-bearing extension engages the further alignment rod so as to transfer force loads from the further alignment rod away from the inner circumferential edge of the first through-hole.

In some embodiments, the bipolar plate sheet of each fuel cell may include a first sheet body including the first through-hole. In some embodiments, the further load-bearing extension may be integrally formed with the first sheet body.

According to a further aspect of the present disclosure, a bipolar plate includes a first bipolar plate sheet including a first outer sheet edge extending around a perimeter of the bipolar plate sheet. The first outer sheet edge includes a first longitudinal edge and a first transverse edge. The bipolar plate further includes a first surface delimited by the first outer sheet edge. The bipolar plate further includes a first load-bearing extension arranged on at least one of the first longitudinal edge or the first transverse edge of the first outer sheet edge. The first load-bearing extension is configured to engage with an alignment bar or a support bar of a fuel cell stack assembling apparatus within which the fuel cell stack is compressed for assembly such that, during compression of the fuel cell stack, the first load-bearing extension engages the alignment bar or the support bar so as to transfer force loads from the alignment bar or the support bar away from the first outer sheet edge and toward a central area of the first bipolar plate sheet.

In some embodiments, the first bipolar plate sheet may include a first sheet body including the first outer sheet edge and the first surface. In some embodiments, the first load-bearing extension may be integrally formed with the first sheet body. In some embodiments, the first load-bearing extension may include a generally planar top extension body having a first extension longitudinal edge that is adjoined to the first longitudinal edge or the first transverse edge of the first outer sheet edge of the first bipolar plate sheet. In some embodiments, the top extension body of the first load-bearing extension may further include a first extension transverse edge and a second extension traverse edge spaced apart from and parallel with the first extension transverse edge that each extend away from the first extension longitudinal edge. In some embodiments, the top extension body of the first load-bearing extension may further include a second extension longitudinal edge spaced apart and parallel to the first extension longitudinal edge. In some embodiments, the second extension longitudinal edge may be configured to engage the alignment bar or the support bar.

According to a further aspect of the present disclosure, a bipolar plate includes a first bipolar plate sheet including a first outer sheet edge extending around a perimeter of the first bipolar plate sheet. The first outer sheet edge including two spaced apart longitudinal edges and two spaced apart transverse edges that extend between opposing ends of the two spaced apart longitudinal edges and interconnect the two spaced apart longitudinal edges. Each longitudinal and traverse edge is entirely straight. The first bipolar plate sheet further includes a first surface delimited by the first outer sheet edge. The first bipolar plate sheet further includes a first load-bearing extension arranged on one of the two spaced apart longitudinal edges or one of the two spaced apart transverse edges of the first outer sheet edge.

The first load-bearing extension includes a top extension body that is generally rectangular and planar and has a first extension longitudinal edge that is adjoined to the one of the two spaced apart longitudinal edges or the one of the two spaced apart transverse edges of the first outer sheet edge of the first bipolar plate sheet. The top extension body of the first load-bearing extension further includes a first extension transverse edge and a second extension traverse edge spaced apart from and parallel with the first extension transverse edge that each extend away from the first extension longitudinal edge. The first load-bearing extension is configured to engage with an alignment bar or a support bar of a fuel cell stack assembling apparatus within which the fuel cell stack is compressed for assembly such that, during compression of the fuel cell stack, the first load-bearing extension engages the alignment bar or the support bar so as to transfer force loads from the alignment bar or the support bar away from the first outer sheet edge and toward a central area of the first bipolar plate sheet.

In some embodiments, the first bipolar plate sheet may include a first sheet body including the first outer sheet edge and the first surface. In some embodiments, the first load-bearing extension may be integrally formed with the first sheet body. In some embodiments, the top extension body of the first load-bearing extension may further include a second extension longitudinal edge spaced apart and parallel to the first extension longitudinal edge. In some embodiments, the second extension longitudinal edge may be configured to engage the alignment bar or the support bar.

### BRIEF DESCRIPTION OF DRAWINGS

This disclosure will be more fully understood from the following detailed description taken in conjunction with the accompanying drawings, in which:

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 is a top view of a bipolar sheet assembly according to the present disclosure, the bipolar sheet assembly configured to be utilized in a fuel cell of the fuel cell system of FIGS. 1A-1D and including a first bipolar sheet having an outer sheet edge and load-bearing extensions arranged on the outer sheet edge;

FIG. 3 is an enlarged view of a load-bearing extension of the bipolar sheet assembly of FIG. 2;

FIG. 4 is a side view of the load-bearing extension of FIGS. 2 and 3, showing that the load-bearing extension includes channels formed therein, and showing a single group of channels;

FIG. 5 is a perspective view of a fuel cell stack assembling apparatus configured to compress a plurality of fuel cells together so as to form a fuel cell stack, showing a plurality of support bars configured to prevent sag of the fuel cell stack;

FIG. 6 is a top view of the fuel cell stack assembling apparatus of FIG. 5, showing a plurality of alignment bars configured to maintain alignment of the plurality of fuel cells in the fuel cell stack and support bars;

FIG. 7 is a top view of a bipolar sheet assembly according to a further aspect of the present disclosure, the bipolar sheet assembly configured to be utilized in a fuel cell of the fuel cell system of FIGS. 1A-1D and including a first bipolar sheet having an outer sheet edge including longitudinal and traverse edges, and load-bearing extensions arranged on both the longitudinal and transverse edges of the outer sheet edge;

FIG. 8 is a top view of a bipolar sheet assembly according to a further aspect of the present disclosure, the bipolar sheet assembly configured to be utilized in a fuel cell of the fuel cell system of FIGS. 1A-1D and including a first bipolar sheet having an outer sheet edge and load-bearing extensions arranged on the outer sheet edge and each including a rounded outer edge shape;

FIG. 9 is a top view of a bipolar sheet assembly according to a further aspect of the present disclosure, the bipolar sheet assembly configured to be utilized in a fuel cell of the fuel cell system of FIGS. 1A-1D and including a first bipolar sheet having an outer sheet edge and load-bearing extensions arranged on the outer sheet edge and each including a triangular shape;

FIG. 10 is a top view of a bipolar sheet assembly according to a further aspect of the present disclosure, the bipolar sheet assembly configured to be utilized in a fuel cell of the fuel cell system of FIGS. 1A-1D and including a first bipolar sheet having an outer sheet edge and load-bearing extensions arranged on the outer sheet edge and each including a semi-circular shape with curved transition edges;

FIG. 11 is a top view of a bipolar sheet assembly according to a further aspect of the present disclosure, the bipolar sheet assembly configured to be utilized in a fuel cell of the fuel cell system of FIGS. 1A-1D and including a first bipolar sheet having an outer sheet edge and load-bearing extensions arranged on the outer sheet edge and each including a trapezoidal shape;

FIG. 12 is a top view of a bipolar sheet assembly according to a further aspect of the present disclosure, the bipolar sheet assembly configured to be utilized in a fuel cell of the fuel cell system of FIGS. 1A-1D and including a first bipolar sheet having an outer sheet edge that is entirely straight and load-bearing extensions arranged on the outer sheet edge;

FIG. 13 is a top view of a bipolar sheet assembly according to a further aspect of the present disclosure, the bipolar sheet assembly configured to be utilized in a fuel cell of the fuel cell system of FIGS. 1A-1D and including a first bipolar sheet having an outer sheet edge that includes a recessed portion and load-bearing extensions arranged in the recessed portion such that the outer edge of the load-bearing extensions is flush with an outer portion of the outer sheet edges;

FIG. 14 is a perspective view of a bipolar sheet assembly according to a further aspect of the present disclosure, the bipolar sheet assembly configured to be utilized in a fuel cell of the fuel cell system of FIGS. 1A-1D and including a two coplanar bipolar sheets having alignment through-holes formed therethrough, each through-hole having a load-bearing extension extending inwardly from the edges of the hole; and

FIG. 15 is a magnified view of a load-bearing extension of a through-hole of the bipolar sheet assembly of FIG. 14.

### DETAILED DESCRIPTION

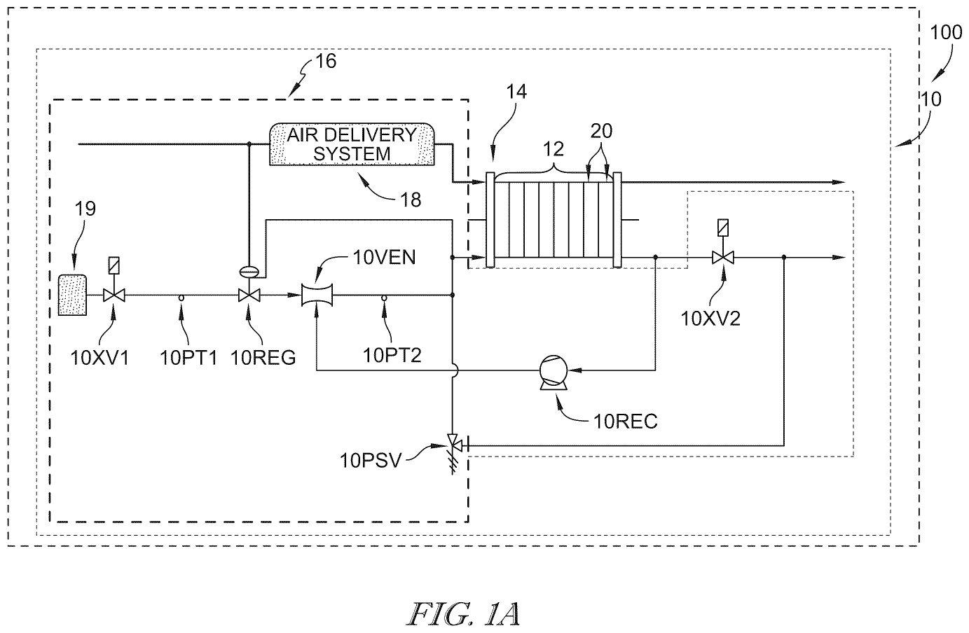

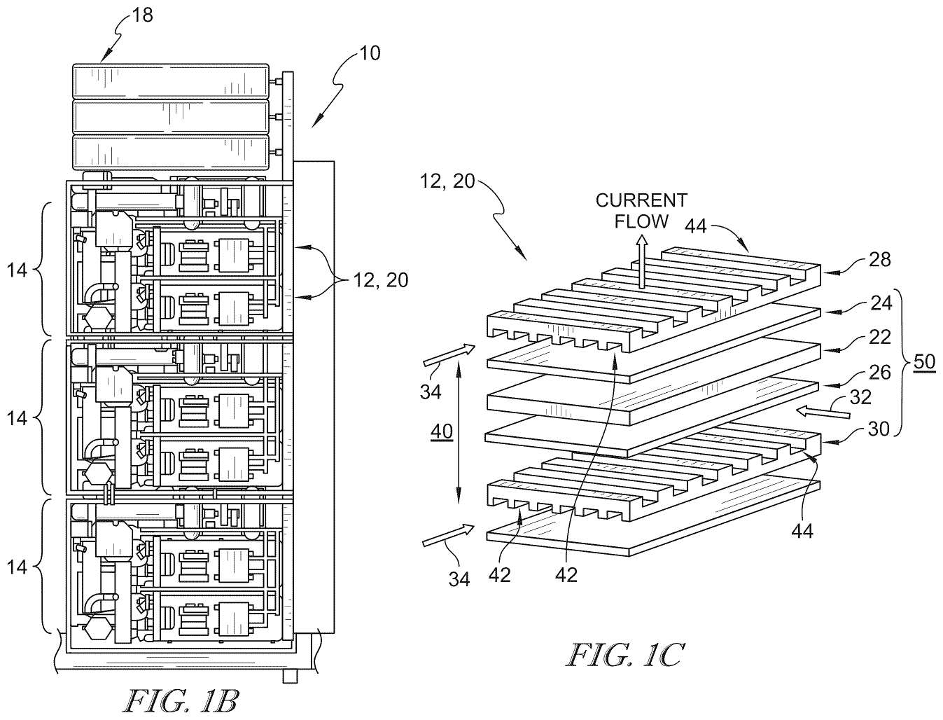

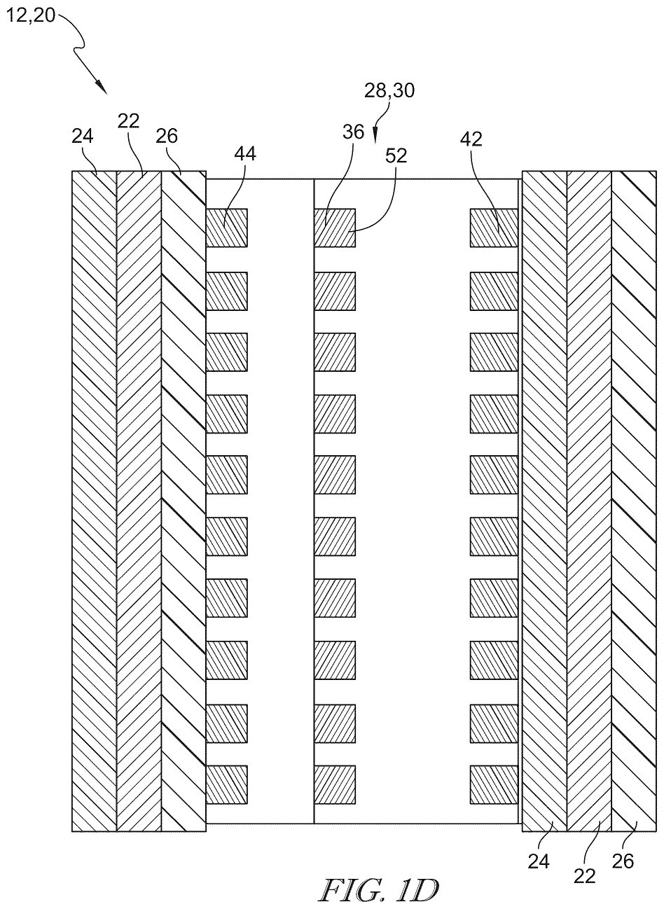

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14, as shown in FIGS. 1A and 1B. In some embodiments, the fuel cell system 10 may comprise one or more fuel cell stacks 12.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling liquid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26. The bipolar plate (BPP) 28, 30 also includes oxidant flow fields 42 for transfer of oxidant 34 on the second, opposite side of the plate 28, 30 for interaction with the gas diffusion layer (GDL) 24.

As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling liquid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments, the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19, as shown in FIG. 1A. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments, the fuel cell system 10 may further include a recirculation pump 10REC downstream of the stack 12 and operably connected to the venturi 10VEN. The fuel cell system 10 may also include a further on/off valve 10XV2 downstream of the stack 12, and a pressure transfer valve 10PSV, as shown in FIG. 1A.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Types of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

The present disclosure is directed to, for example, a fuel cell stack 112, system of assembling a fuel cell stack 112, and related methods of forming the fuel cell stack 112. The fuel cell stack 112, system, and methods include at least one fuel cell 120 including a bipolar sheet assembly 128 having load-bearing extension bodies 154, 194 configured to engage an alignment bar 236 or a support bar 228 of a fuel cell stack assembling apparatus 212 so as to transfer force loads from the alignment bar 236 and/or the support bar 228 away from an outer sheet edge 146, 186 of the bipolar sheet assembly 128, also referred to as a bipolar plate 128, and so as to maintain alignment of the plurality of fuel cells 120 in the fuel cell stack 112.

The fuel cell stack 112 and the related systems and methods described herein may be utilized with the fuel cell system 10 described above. As such, any reference to a fuel cell system in the description of the fuel cell stack 112 and the related systems and methods may also refer to the fuel cell system 10. Similarly, other related components of the fuel cell system 10, including the fuel cell stack 12, the fuel cell modules 14, and the like may be referred to interchangeably with the fuel cell stack 112, the fuel cells 120, and similar components as described herein.

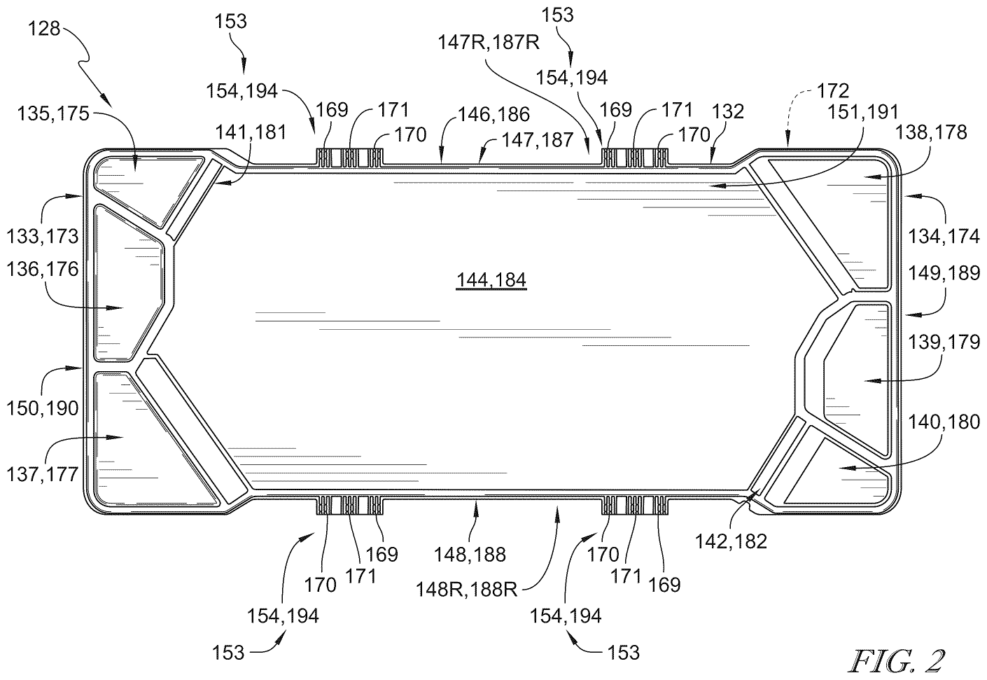

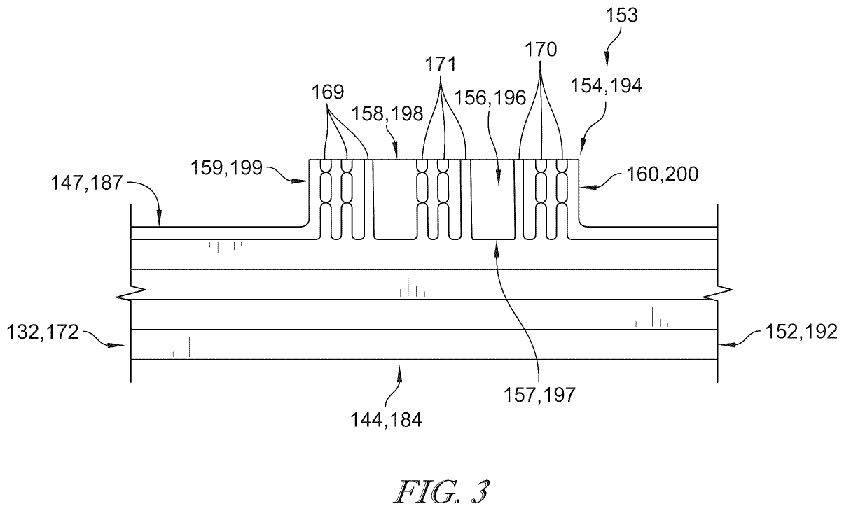

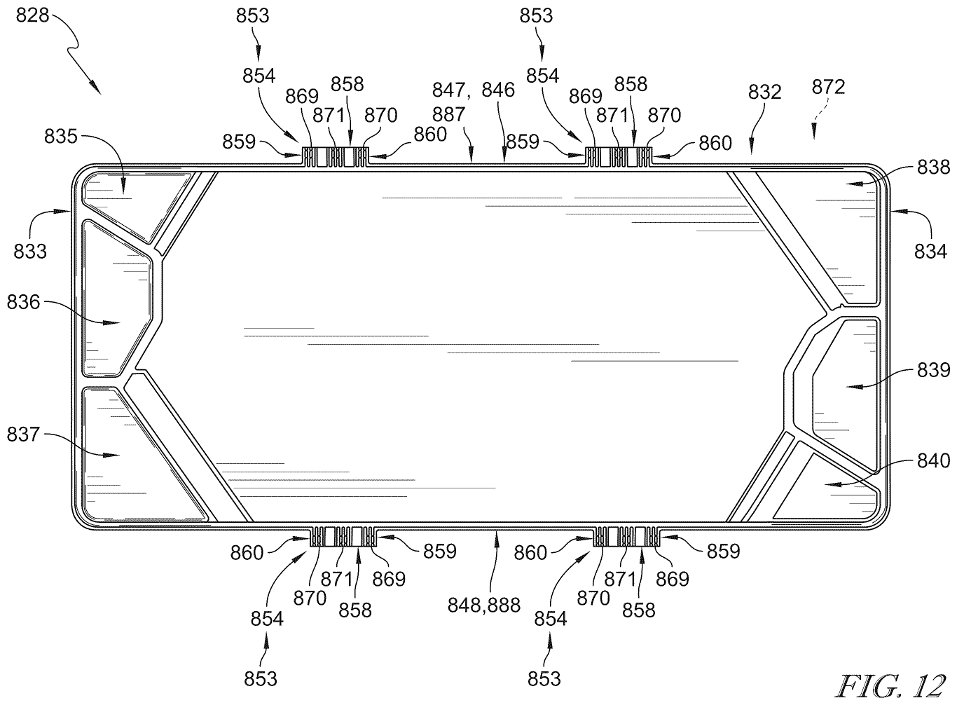

An exemplary bipolar plate 128 configured to be utilized as the bipolar plates 28, 30 in the fuel cell 20 of the fuel cell stack 12 described above, or the fuel cells 120 of the fuel cell stack 112 described below, is shown in FIGS. 2-4. The bipolar plate 128 may be comprised of formed sheets of material bonded or welded adjacent to each other. By way of non-limiting examples, the bipolar plate 128 may be formed of one, two, three, or more sheets. In the illustrated embodiment, the bipolar plate 128 is formed of two layered sheets 132, 172, as shown in FIG. 2 and in additional detail in the embodiment shown in FIG. 12. In some embodiments, one of the sheets 132, 172 is formed as a cathode sheet for interaction with a cathode gas diffusion layer 24 and the other one of the sheets 132, 172 is formed as an anode for interaction with an anode gas diffusion layer 26.

The material of the sheets 132, 172 may be about 20% to about 100% metal, including any percentage or range of percentages of metal comprised therein. Typically, a sheet of a metal bipolar plate 128 may comprise about 50% to about 100% metal, including any percentage or range of percentage of metal comprised therein. In an exemplary embodiment, the sheets 132, 172 of the metal bipolar plate 128 may comprise about 50% to about 100% metal, including any percentage or range of percentage of metal comprised therein. In another embodiment, the sheets 132, 172 of the metal bipolar plate 128 may comprise about 90% to about 100% metal, including any percentage or range of percentage of metal comprised therein.

The material and structure of the metal bipolar plate 128 may be important to the conductivity of the fuel cell 120 or the fuel cell stack 112. In some embodiments, the material of the bipolar plate 128 is graphite. Similarly, the material of the bipolar plate 128 may or may not be any similar or different powder-based product that may be prepared by an impregnation and/or solidifying process, such as graphite-based powders. Graphite and other such materials of the bipolar plate 128 do not have the capacity to retain the necessary strength or uniformity to support a fuel cell 120 or a fuel cell stack 112 without maintaining a certain minimum width or thickness. However, metal as a material of the bipolar plate 128 has considerably lower limitations and/or restrictions.

The metal of the bipolar plate 128 may be any type of electrically conductive metal, including, but not limited to, austenitic stainless steel (304L, 316L, 904L, 310S), ferritic stainless steel (430, 441, 444, Crofer), Nickel based alloys (200/201, 286, 600, 625), titanium (Grade 1, Grade 2), or aluminum (1000 series, 3000 series). Exemplary metals comprised by the metal bipolar plate 128 may be steel, iron, nickel, aluminum, and/or titanium, or combinations thereof.

The sheets 132, 172 of the metal bipolar plate 128 may be sealed, welded, stamped, structured, bonded, and/or configured to provide the flow fields for the fuel cell fluids (e.g., one, two, three, or more fluids). One or more sheets 132, 172 of the metal bipolar plate 128 are configured to be in contact, to overlap, to be attached, or connected to one another in order to provide the flow fields for the fuel cell fluids.

In some embodiments, one or more sheets 132, 172 of the metal bipolar plate 128 may be coated for corrosion resistance using any method known in the art (e.g., spraying, dipping, electrochemically bathing, adding heat, physical vapor deposition (PVD), chemical vapor deposition (CVD), etc.). In some embodiments, the coatings may be metal based and include, but not limited to, elements such as zinc, chromium, nickel, gold, platinum, and various alloys or combinations thereof. In other embodiments, the coatings may be a graphite-based coating that protects, reduces, delays, and/or prevents the bipolar plate 128 from corroding (e.g., rusting, deteriorating, etc.). Since graphite has the inability to oxidize, it may be advantageous to coat the metal of the bipolar plate 128 with a graphite and/or a graphite-based coating.

Illustratively, the first sheet 132 of the bipolar plate 128 includes a first header region 133 and a second header region 134, as shown in FIG. 2. The first header region 133 includes a first manifold 135 (also referred to as a port), a second manifold 136, and a third manifold 137. Each manifold 135, 136, 137 may be formed as a sizable opening formed towards one side of the first sheet 132. In some embodiments, the outer contours of each manifold 135, 136, 137 may match the contour of the outer edge of the sheet 132. In the illustrated embodiment, the first manifold 135 is located in an upper left corner of the bipolar plate 128. The first manifold 135 includes a feed portion 141 configured to facilitate feeding of the fluids described above into the active area 144, 184 of the bipolar plate 128 so as to interact with the associated gas diffusion layer 24, 26. A person skilled in the art will understand that a feed portion 141 is not limited to only the first manifold 135, and that other manifolds 136, 137 may also include feed portions in other embodiments of the present disclosure.

Similar to the manifolds 135, 136, 137, the first sheet 132 of the bipolar plate 128 further includes a fourth manifold 138, a fifth manifold 139, and a sixth manifold 140, as shown in FIG. 2. Each manifold 138, 139, 140 may be formed as a sizable opening formed in the first sheet 132 opposite the side on which the manifolds 135, 136, 137 are formed. In some embodiments, the outer contours of each manifold 138, 139, 140 may match the contour of the outer edge of the first sheet 132. In the illustrated embodiment, the sixth manifold 140 is located on a lower right corner of the bipolar plate 128. The sixth manifold 140 includes an outlet portion 142 configured to facilitate removal of the fluids described above away from the active area 144, 184 of the bipolar plate 128. In the illustrated embodiment, the manifolds 135, 138, and 139 are formed as inlet manifolds, and the manifolds 136, 137, and 140 are formed as outlets. A person skilled in the art will understand that different manifolds may be formed as inlets and outlets, as well as combinations that include all inlets and outlets formed on the same side as the plate, or on differing sides of the plate as shown in the illustrated embodiment.

A person skilled in the art will also understand that, in some embodiments such as the embodiment shown in FIG. 2, the second sheet 172 is formed identically to the first sheet 132. Accordingly, identical components are formed on the second sheet 172, such as the manifolds, inlets, and outlets described above with regard to the first sheet 132. As such, similar reference numbers, in particular 173, 174, 175, 176, 177, 178, 179, 180, 181, 182, and 184, are shown in FIG. 2 to represent each of the identical components as described in detail herein for the first sheet 132 and the second sheet 172. Although the description below will make reference to each sheet including a particular component, a person skilled in the art will understand that, in other embodiments, the sheets 132, 172 may not be formed identically, and thus the corresponding components on each sheet 132, 172 may be formed differently from each other.

Illustratively, the sheets 132, 172 are layered directly on top of each other to form the bipolar plate 128. Each sheet 132, 172 includes the manifolds, inlets, and outlets described above, and are arranged on top of each other. A person skilled in the art will understand that, although the manifolds are shown conceptually as the shapes shown in FIG. 2, the manifolds may be formed of different shapes in order to suit the consumption of their respective fluids and/or the respective fuel cell 120 or fuel cell stack 112.

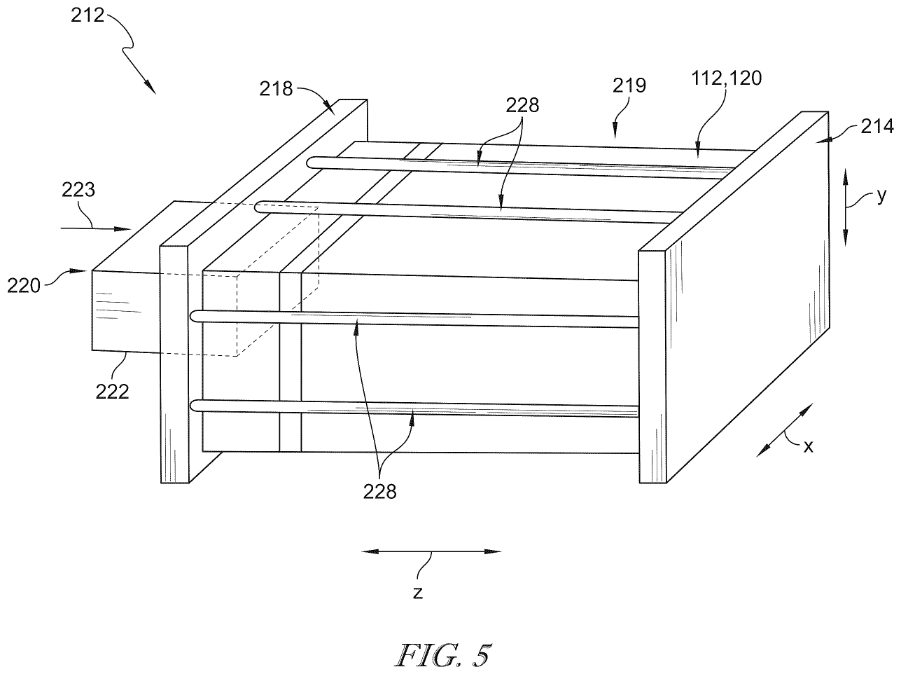

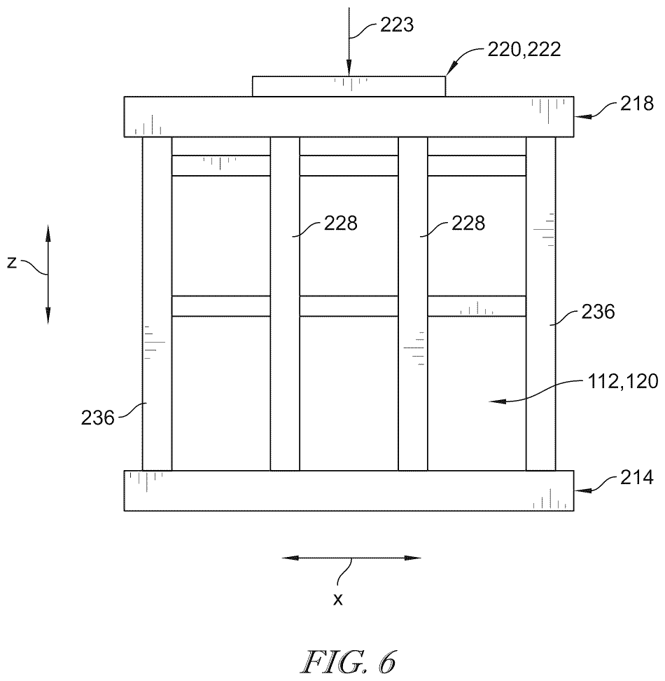

As will be described in more detail below, a fuel cell stack assembling apparatus 212 may be utilized to assemble a stack of bipolar plates 128, membrane electrode assemblies (MEA) 22, and/or gas diffusion layers (GDL) 24, 26, to form a fuel cell stack 112, as shown in FIGS. 5 and 6. In a fuel cell stack, hundreds of bipolar plates 128 are stacked together in series under compression to ensure the flows of reactant gases and coolant fluid therethrough, as well as to ensure optimal flow of electrical current. As the dimensions for the sub-components, such as the bipolar plates 128, the membrane electrode assemblies (MEA) 22, the gas diffusion layers (GDL) 24, 26, and seals (not shown), all have tight tolerances, it is beneficial to have stringent requirements for plate misalignment (e.g., less than 0.20 mm offset from each other) to guarantee the proper alignment of the sub-components.

For example, seal to seal alignment is beneficial for the leak-free flow of gases and fluid. Similarly, landings formed on the bipolar plates 128 should be as aligned as possible, since, for example, misaligned landings on an anode plate may crush into the adjacent cathode plate channel slots. Such crushing may tear the gas diffusion layer (GDL) 24, 26 (also referred to as GDL over-compression), and the subsequent broken gas diffusion layer (GDL) 24, 26 fibers may poke the thin membrane of the membrane electrode assembly (MEA) 22 causing cross over leak and electrical shorting. This may lead to local electrical shorting and the bipolar plates 128 melting, which may result in fuel cell stack 112 failure.

Illustratively, the fuel cell stack assembling apparatus 212 may include at least one alignment bar 236 (e.g., one alignment bar on each side of the bipolar plates 128) to keep the bipolar plates 128 in sufficient alignment. When the bipolar plates 128 are misaligned in either of the X and Y directions (see FIG. 5) due to stack compression in the Z-direction, the alignment bar 236 (see FIG. 6) may push against the thin metal outer sheet edges 146, 186 of the bipolar plate 128 to correct the alignment of the fuel cells 120 in the fuel cell stack 112. Because the metal of the bipolar plate 128 is typically thin (e.g., approximately 0.1 mm) and formed from a relatively soft material, the outer sheet edges 146, 186 of the misaligned bipolar plate 128, which are in contact with the alignment bar 236 during correction, will bend elastically and/or deform plastically instead of pushing the whole bipolar plate 128 for alignment. The deformations may compromise structural integrity and operational capacity of the bipolar plates 128 and the overall fuel cell 120 and the fuel cell stack 112.

Similarly, the bipolar plates 128 of the fuel cell stack 112 may begin to sag downwardly due to gravity and torque loss after compression and during initial operation, which in turn may cause the bipolar plates 128, and thus the fuel cells 120, to be out of alignment. To compensate for sag, at least one support bar 228 may be arranged under the fuel cell stack 112 to provide mechanical support and prevent the bipolar plates 128 from sagging during torque loss, as shown in FIG. 5. Likewise, due to the thinness of the bipolar plates 128, and thus low mechanical strength, the bipolar plates 128 may deform locally due to the support bars 228 pushing the bipolar plate 128 for correction. As described above, these deformations may compromise structural integrity and operational capacity of the bipolar plates 128 and the overall fuel cell 120 and the fuel cell stack 112.

In order to prevent deformation of the outer sheet edges 146, 186 of the sheets 132, 172 of the bipolar plate 128 of each fuel cell 120 during compression and assembly of the fuel cell stack 112, each sheet 132, 172 can be formed with load-bearing extension bodies 154, 194 extending away from the outer sheet edges 146, 188 of the sheets 132, 172, as shown in detail in FIGS. 2-4. The load-bearing extension bodies 154, 194, which together may form the load-bearing extension 153, are configured to engage the alignment bars 236 and/or the support bars 228 so as to transfer force loads from the alignment bars 236 and/or the support bars 228 away from the outer sheet edges 146, 186 and toward a central area, or the active area 144, 184, of the sheets 132, 172. The load-bearing extension bodies 154, 194 maintain the alignment of the bipolar plates 128, and thus the fuel cells 120 of the fuel cell stack 112, while also preventing the deformation that may occur when the alignment or support bars 236, 228 press on the outer sheet edges 146, 186.

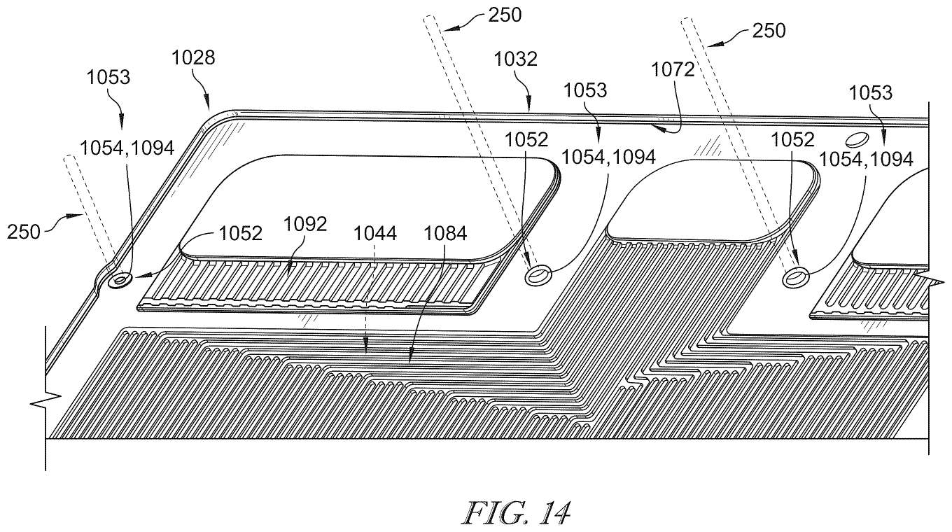

As shown in FIG. 2, the bipolar plate 128 includes the two sheets 132, 172 (see FIG. 14 for detailed illustration of an exemplary pair of sheets stacked adjacent to each other to form a bipolar plate). Each sheet 132, 172 includes the outer sheet edge 146, 186 extending around a perimeter of the sheet 132, 172. Each outer sheet edge 146, 186 may include a first longitudinal edge 147, 187, a second longitudinal edge 148, 188 opposite the first longitudinal edge 147, 187, and two transverse edges 149, 189, 150, 190 on opposite sides of the sheets 132, 172 and extending between the first and second longitudinal edges 147, 187, 148, 188. In some embodiments, the longitudinal edges 147, 187, 148, 188 may include a recess 147R, 187R, 148R, 188R. The first and second longitudinal edges 147, 187, 148, 188 may be parallel and the two transverse edges 149, 189, 150, 190 may also be parallel so as to form a rectangular-shaped bipolar plate 128, although other shapes may be utilized as will be understood by a person skilled in the art.

Illustratively, the two sheets 132, 172 are stacked adjacent to each other such that the outer sheet edge 146 of the first sheet 132 aligns entirely with the outer sheet edge 186 of the second sheet 172, as shown in FIG. 2 and further suggested in FIG. 5. Each sheet 132, 172 includes a surface 151, 191 including a plurality of channels 152, 192 defining the active area 144, 184 of the first sheet 132, as shown in FIGS. 2 and 3. FIG. 14 more clearly shows a plurality of channels 1092 of a second sheet 1072 (although numbered in the 1000 series, the second sheet 1072 generally corresponds to the second sheet 172 of FIG. 2). In some embodiments, the longitudinal edges 147, 187, 148, 188 and the transverse edges 149, 189, 150, 190 are located outside of the active area 144, 184.

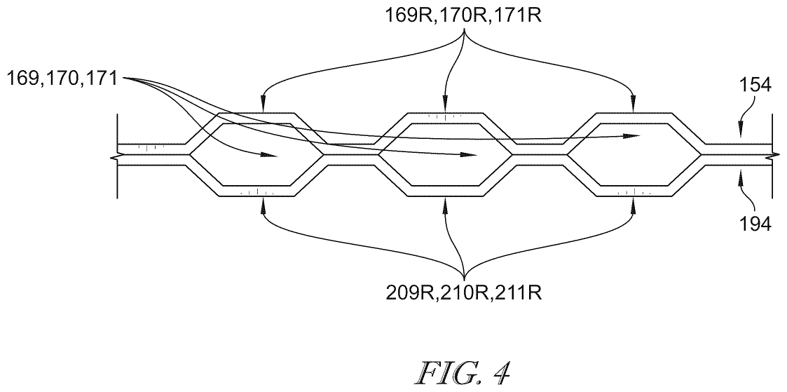

As shown in FIG. 2 and in greater detail in FIGS. 3 and 4, the bipolar plate 128 includes at least one load-bearing extension 153 arranged on the perimeter of the bipolar plate 128, in particular on the outer sheet edges 146, 186 of the sheets 132, 172. Illustratively, the bipolar plate 128 includes a plurality of load-bearing extensions 153 arranged around the perimeter of the bipolar plate 128, as can be seen in FIG. 2. Specifically, one or more load-bearing extensions 153 may be arranged on the longitudinal edges 147, 187, 148, 188 and, in some embodiments, on the transverse edges 149, 189, 150, 190.

As will be described in greater detail below, each load-bearing extension 153 is configured to engage with the alignment bar 236 or the support bar 228 of the fuel cell stack assembling apparatus 212 within which the fuel cell stack 112 is compressed for assembly, as shown in FIGS. 5 and 6. Thus, during compression of the fuel cell stack 112, each load-bearing extension 153 engages the alignment bar 236 and/or the support bar 228 so as to transfer the force loads that the alignment bar 236 and/or the support bar 228 place on the bipolar plate 128 away from the outer sheet edges 146, 186 of the sheets 132, 172 and toward a central area of the bipolar plate 128 (e.g., toward the active area 144, 184 of the sheet 132, 172). As a result, the alignment bar 236 and/or the support bar 228 aligns the plurality of bipolar plates 128 in the fuel cell stack 112 without causing deformations on the outer sheet edges 146, 186 of the sheets 132, 172.

Illustratively, as shown in detail FIG. 3, each load-bearing extension 153 may be formed from two identical sheets, also referred to as a top extension body 154 and a bottom extension body 194, that are stacked together to form the load-bearing extension 153. FIG. 4 shows a clearer view of the two separate load-bearing extension bodies 154, 194, in particular showing an enlarged view of a portion of the top extension body 154 arranged on top of the identical bottom extension body 194 and a single group of channels 169, 170, 171. A person skilled in the art will understand that the load-bearing extensions 153 can also be formed as a single, monolithic piece or any other method of fabrication known in the art. Forming the load-bearing extension 153 from two load-bearing extension bodies 154, 194 may simplify manufacturing, in particular with regard to the optional channels 169, 170 formed in the load-bearing extensions 153.

Illustratively, each load-bearing extension body 154, 194 is integrally formed with the respective sheet 132, 172, as shown in FIGS. 2 and 3. In this way, the entire sheet 132, 172 can be manufactured as a single piece that includes the load-bearing extension body 154, 194. Thus, when the sheets 132, 172 are joined together, the load-bearing extension bodies 154, 194 can be joined together as well to form the final bipolar plate 128 and the load-bearing extensions 153. A person skilled in the art will understand that the load-bearing extension bodies 154, 194 can instead be separate pieces from the sheets 132, 172, and can be adjoined to the sheets 132, 172 using coupling, fastening, and/or adhering means known in the art and described herein (welding, bolting, etc.). In other embodiments, the load-bearing extension 153 is formed as single piece coupled to the bipolar plate 128 outer sheet edges 146, 186, either to only one of the outer sheet edges 146, 186 or both outer sheet edges 146, 186.

As can be seen in FIG. 3, each load-bearing extension body 154, 194 includes a generally planar surface 156, 196 and includes a generally rectangular shape. In particular, each load-bearing extension body 154, 194 can include a first extension longitudinal edge 157, 197, a second extension longitudinal edge 158, 198 opposite the first extension longitudinal edge 157, 197, and extension traverse edges 159, 199, 160, 200 on opposite sides of the load-bearing extension bodies 154, 194 and extending between the first and second extension longitudinal edges 157, 197, 158, 198. The first and second extension longitudinal edges 157, 197, 158, 198 may be parallel and the two extension transverse edges 159, 199, 160, 200 may also be parallel so as to form a rectangular-shaped load-bearing extension 153, although other shapes may be utilized as will be understood by a person skilled in the art.

In some embodiments, the first extension longitudinal edge 157, 197 of each load-bearing extension body 154, 194 can be adjoined to and parallel with the respective longitudinal edge 147, 187 of the respective sheet 132, 172, as shown in FIG. 3. As a result, the opposing second extension longitudinal edges 158, 198 is spaced apart from the outer sheet edges 146, 186 of the sheets 132, 172 of the bipolar plate 128. As such, the alignment bar 236 and/or the support bar 228 of the fuel cell stack assembling apparatus 212 are configured to contact and engage the second extension longitudinal edges 158, 198 of the load-bearing extensions 153 instead of contacting the outer sheet edges 146, 186 of the sheets 132, 172, thus preventing deformation of the outer sheet edges 146, 186.

In some embodiments, as shown in FIGS. 3 and 4, the top and bottom extension bodies 154, 194 may further include a plurality of ridges 169R, 209R, 170R, 210R, 171R, 211R that protrude away from the respective planar surface 156, 196 so as to form a hollow space underneath the ridge 169R, 209R, 170R, 210R, 171R, 211R. Specifically, the ridges 169R, 170R, 171R formed on the top extension body 154 are aligned with the ridges 209R, 210R, 211R formed on the bottom extension body 194 such that the hollow spaces underneath the ridges form channels 169, 170, 171, as shown in detail in FIG. 4 (which shows a single group of the channels 169, 170, 171 that can correspond to any of the three groups of channels 169, 170, 171). The channels 169, 170, 171 may add additional structural stiffness and malleability in response to compression forces acting on the load-bearing extension 153. Spacing the groups of channels 169, 170, 171 out along the longitudinal length of the load-bearing extension bodies 154, 194 aids in dispersing the forces acting on the load-bearing extension 153. A person skilled in the art will understand that other arrangements of groups and number of channels may be utilized.

In some embodiments, as can be seen in FIGS. 3 and 4, the ridges 169R, 209R, 170R, 210R, 171R, 211R extend in a direction from the first extension longitudinal edges 157, 197 to the second extension longitudinal edges 158, 198. As shown in FIG. 4, the channels 169, 170, 171 may be open at the second extension longitudinal edges 158, 198.

In some embodiments, the channels 169, 170, 171 can have a width as measured between the surfaces of the ridges 169R, 209R, 170R, 210R, 171R, 211R in a range of 0.5 mm to 2.5 mm. In some embodiments, the width of the channels 169, 170, 171 may be in a range of 0.8 mm to 2.2 mm. In some embodiments, the width of the channels 169, 170, 171 may be in a range of 1 mm to 2 mm. In some embodiments, the width of the channels 169, 170, 171 may be approximately 1.5 mm.

As can be seen in FIGS. 3 and 4, the top and bottom extension bodies 154, 194 of the load-bearing extension 153 are formed to be entirely coplanar with the first and second sheets 132, 172 of the bipolar plate 128. A person skilled in the art will understand that the top and bottom extension bodies 154, 194 do not have to be entirely coplanar with the sheets 132, 172 to provide load distribution and alignment functionalities, although the entirely coplanar arrangement may provide a maximum stiffness and thus maximum load distribution and alignment functionalities.

A person skilled in the art will understand that the load-bearing extensions 153, as well as the bipolar plate 128, may generally be formed by manufacturing means known in the art. By way of non-limiting examples, the load-bearing extensions 153 may be formed via laser welding of anode and cathode plates (e.g., sheets 132, 172) to form the load-bearing extensions 153 integrally. Alternatively, the load-bearing extensions 153 may be formed by configuring additional material in various forms, such as, but not limited to, sheets, strips, pre-formed circular pieces, semi-circles pipes, triangular pieces, rectangular pieces, trapezoidal pieces, bump circular pieces, and the like. A person skilled in the art will understand that these features may be in any orientation in alternative embodiments that are within the spirit of this disclosure.

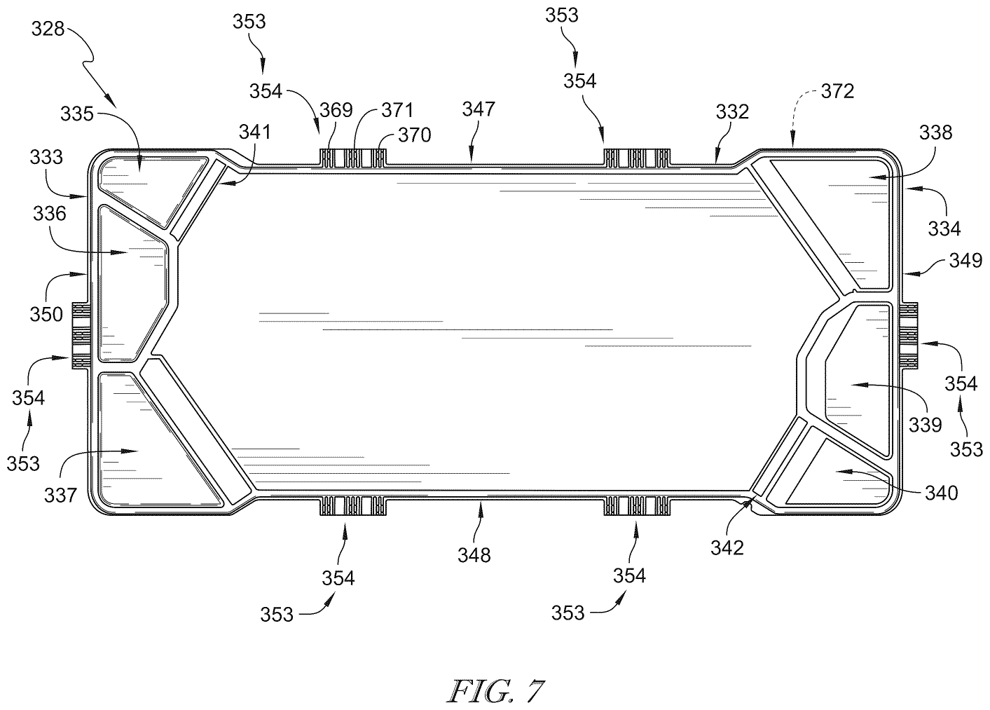

Illustratively, as shown in FIG. 2, the bipolar plate 128 includes four load-bearing extensions 153 extending away from the outer sheet edges 146, 186 of the sheets 132, 172. In some embodiments, the number of load-bearing extensions 153 may correspond to the number of alignment bars 236 and/or support bars 228. In this non-limiting example, the bipolar plate 128 includes four load-bearing extensions 153 because the fuel cell stack assembling apparatus 212 includes four alignment bars 236. In other embodiments, additional or fewer load-bearing extensions 153 may be arranged on the bipolar plate 128, such as the embodiment shown in FIG. 7 in which two additional load-bearing extensions 153 (shown as 353 in FIG. 7) are arranged on the transverse edges 149, 189, 150, 190.

A person skilled in the art will understand that any number of load-bearing extensions 153 may be utilized in order to effectively transfer loads and align the plurality of bipolar plates 128 and the fuel cells 120 based on the number of alignment bars 236 and/or support bars 228 of the fuel cell stack assembling apparatus 212. Moreover, a person skilled in the art will understand that the locations of such load-bearing extensions 153 may be chosen or designed on a bipolar plate 128 to act as plate structural points configured to move the entirety of the bipolar plates 128. For example, the external forces can be transferred to other parts of the bipolar plates 128 without causing significant damage or deformation to the bipolar plate 128 and/or the load-bearing extension 153.

As shown in FIGS. 5 and 6, the fuel cell stack assembling apparatus 212 includes an end plate 214 and a compression plate 218 configured to support and compress the plurality of fuel cells 120 in a stacked arrangement (see configuration of the fuel cell stack 112 in FIG. 5). In particular, a stacked arrangement may be an arrangement in which each individual fuel cell 120 is stacked or sandwiched against an adjoining fuel cell 120, in particular on their planar surfaces, so as to form a fuel cell stack 112 of fuel cells 120, as shown in FIG. 5.

The fuel cell stack assembling apparatus 212 may further include the plurality of support bars 228 that extend between the end plate 214 and the compression plate 218, as shown in FIG. 5. As shown in FIG. 6, the fuel cell stack assembling apparatus 212 further includes the plurality of alignment bars 236 arranged thereon and configured to maintain alignment of the fuel cells 120, and thus, the overall fuel cell stack 112. A stack-receiving space 219 is defined within the space enclosed by the plates 214, 218, the support bars 228, and the alignment bars 236. The fuel cells 120 are arranged within the stack-receiving space 219 in the stacked arrangement for compression and assembly into an assembled fuel cell stack 112.

In some embodiments, at least one support bar 228 of the plurality of support bars 228 is configured to be attached to a portion of the fuel cell stack 112 and is also configured to detach from the fuel cell stack assembling apparatus 212 and remain attached to the fuel cell stack 112 after removal of the fuel cell stack 112 from the fuel cell stack assembling apparatus 212. As a result, the at least one support bar 228 can continue to prevent potential sag of the fuel cell stack 112 after its removal from the fuel cell stack assembling apparatus 212. In some embodiments, the alignment bars 236 and the support bars 228 may be formed as the same structures. For example, one or more of the alignment bars 236 may be arranged below the fuel cell stack 112 as the fuel cell stack 112 is compressed by the fuel cell stack assembling apparatus 212, and thus may prevent sagging of the fuel cell stack 112, while also maintaining alignment of the fuel cells 120 of the fuel cell stack 112.

As shown in FIGS. 5 and 6, a press assembly 220 is arranged adjacent to the compression plate 218, while the end plate 214 is fixed and stationary. The press assembly 220 may include an actuator 222 or a piston 222, operated by any known means in the art such as hydraulically, electrically, pneumatically, or the like. The press assembly 220 is configured to apply a force to the compression plate 218 in the Z-direction (shown as arrow 223 in FIGS. 5 and 6) in order to compress the fuel cell stack 112 together against the end plate 214. In this way, each fuel cell 120 of the fuel cell stack 112 is compressed together for assembly.

During compression of the fuel cell stack 112, the alignment bars 236, which are designed to maintain alignment of each fuel cell 120 of the fuel cell stack 112, may potentially cause deformations in the sides of the bipolar plates 128 of the fuel cells 120 (see FIG. 7). Moreover, the support bars 228, which are designed to prevent sagging of the fuel cell stack 112, may also potentially cause deformations in the sides of the bipolar plates 128 of the fuel cells 120 (see FIG. 7). These deformations can be particularly harmful to the fuel cell stack 112, compromising the structural integrity of the bipolar plates 128, and thus, the overall fuel cell stack 112. To prevent this deformation, the load-bearing extensions 153 are arranged on at least some of the bipolar plates 128 in the fuel cell stack 112. In some embodiments, the load-bearing extensions 153 are arranged on every bipolar plate 128 in the fuel cell stack 112.

Each load-bearing extension 153 of the bipolar plate 128 is aligned with adjacent load-bearing extensions 153 of adjacent bipolar plates 128, in particular along the second extension longitudinal edges 158, 198 and extension transverse edges 159, 199, 160, 200. As a result of this alignment, engagement of the alignment bars 236 and/or the support bars 228 with the adjacent load-bearing extensions 153 aligns the adjacent bipolar plates 128 with each other, and thus, aligns the adjacent fuel cells 120 with each other. In this way, the entire fuel cell stack 112 can have its alignment maintained without damage caused to the fuel cells 120 by the alignment bars 236 and/or the support bars 228.

A method of forming the fuel cell stack 112 according to the present disclosure includes a first operational step of arranging the plurality of fuel cells 120 in a stacked arrangement (see stacked configuration of the fuel cells 120 in the fuel cell stack 112 shown in FIG. 5) within the stack-receiving space 219 of the fuel cell stack assembling apparatus 212. Each fuel cell 120 of the plurality of fuel cells 120 includes the first bipolar plate 128 having the sheets 132, 172. The sheets 132, 172 include the outer sheet edge 146, 186 extending around a perimeter of the sheet 132, 172, the surface 151, 191, and the first load-bearing extension arranged 153 on the outer sheet edge 146, 186.

The method may further include a second operational step of aligning each fuel cell 120 of the plurality of fuel cells 120 with each other via alignment of the outer sheet edges 146, 186 and the first load-bearing extensions 153 of each fuel cell 120. The method may further comprise a third operational step of providing at least one alignment bar 236 or support bar 228 outside of and adjacent to the plurality of fuel cells 120 arranged in the stack-receiving space 119 and configuring the alignment bar 236 or the support bar 228 to contact at least one first load-bearing extension 153 of the fuel cell 120 of the plurality of fuel cells 120 in order to maintain alignment of the plurality of fuel cells 120 within the stack-receiving space 219.

The method may further include a fourth operational step of compressing each fuel cell 120 of the plurality of fuel cells 120 together via the press assembly 220 of the fuel cell stack assembling apparatus 212 such that the at least one first load-bearing extension 153 engages with the alignment bar 236 or the support bar 228 of the fuel cell stack assembling apparatus 212 so as to transfer force loads from the alignment bar 236 or the support bar 228 away from the outer sheet edge 146, 186 and toward a central area of the respective sheet 132, 172 so as to maintain alignment of the plurality of fuel cells 120.

Other embodiments of bipolar plates 328, 428, 528, 628, 728, 828, 928, 1028 are shown in FIGS. 7-15. The bipolar plates 328, 428, 528, 628, 728, 828, 928, 1028 are similar to the bipolar plate 128 shown in FIGS. 2-4 and described herein. Accordingly, similar reference numbers in the 300, 400, 500, 600, 700, 800, 900, and 1000 series indicate features that are common between the bipolar plate 128 and the bipolar plates 328, 428, 528, 628, 728, 828, 928, 1028. The description of the bipolar plate 128 is incorporated by reference to apply to the bipolar plates 328, 428, 528, 628, 728, 828, 928, 1028, except in instances when it conflicts with the specific description and the drawings of the bipolar plates 328, 428, 528, 628, 728, 828, 928, 1028.

A person skilled in the art will understand that the various concepts described in these and all other embodiments described herein may be utilized in any combination with each other. As a non-limiting example, a combination of differently shaped load-bearing extensions may be utilized on the same bipolar plate sheet, such as two load-bearing extensions on one longitudinal edge being a first shape and two load-bearing extensions on one longitudinal edge being a second, different shape. As another non-limiting example, the load-bearing extensions described herein can be utilized on bipolar plate sheets having a recess formed in the longitudinal edges or bipolar plate sheets without said recess.

Similar to the bipolar plate 128 described above, the bipolar plates 328, 428, 528, 628, 728, 828, 928, 1028 shown in FIGS. 7-15 each include a double sheet 332, 372, 432, 472, 532, 572, 632, 672, 732, 772, 832, 872, 932, 972, 1032, 1072 configuration, each sheet 332, 372, 432, 472, 532, 572, 632, 672, 732, 772, 832, 872, 932, 972, 1032, 1072 having similar manifold and active area arrangements (see reference numbers in FIGS. 7-15 that correspond to the reference numbers of FIGS. 2-4). For simplicity, only the first sheets 332, 432, 532, 632, 732, 832, 932, 1032 are shown in FIGS. 7-15.

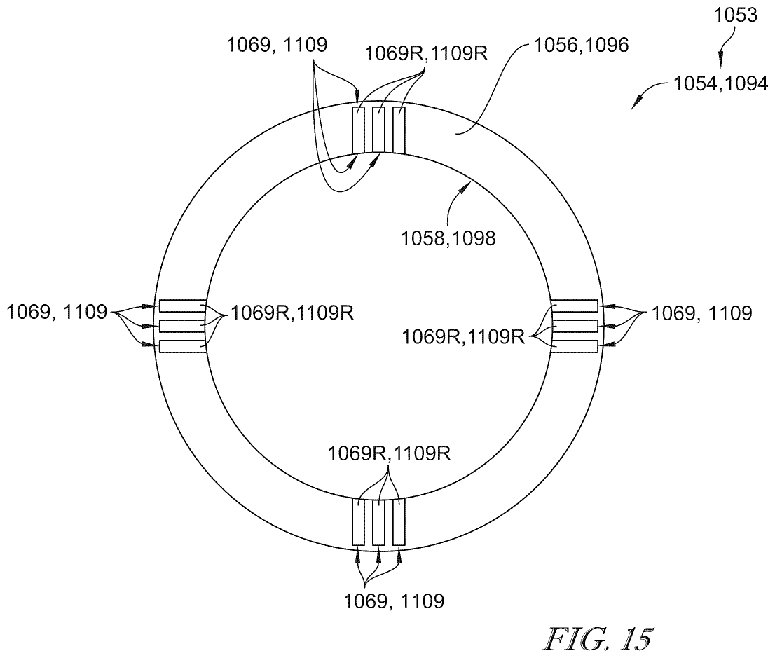

The embodiments shown in FIGS. 7-13 include alternative load-bearing extensions that differ from the load-bearing extensions 153 described above. FIGS. 14 and 15 include alignment through-holes 1052, which will be described in greater detail below. Nevertheless, the load-bearing extensions described below and shown in FIGS. 7-13 retain the double extension body configuration and arrangement on the bipolar plate sheets as those described above with regard to the load-bearing extension 153. For simplicity, only the top extension bodies are shown in FIGS. 7-13.

FIG. 7 shows a plurality of load-bearing extensions 353 each having a top extension body 354 and a bottom extension body (not shown). The load-bearing extensions 353 are formed the same as the load-bearing extensions 153 described above, but instead of only including load-bearing extensions 153 on the longitudinal edges 347, 348 of the sheets 332, 372, the bipolar plate 328 includes six load-bearing extensions 353, with four load-bearing extensions 353 formed on the longitudinal edges 347, 348 and two load-bearing extensions 353 formed on the transverse edges 349, 350. The extra two load-bearing extensions 353 formed on the transverse edges 349, 350 may engage additional alignment bars 236 and/or support bars 228 positioned adjacent to the transverse edges 349, 350.

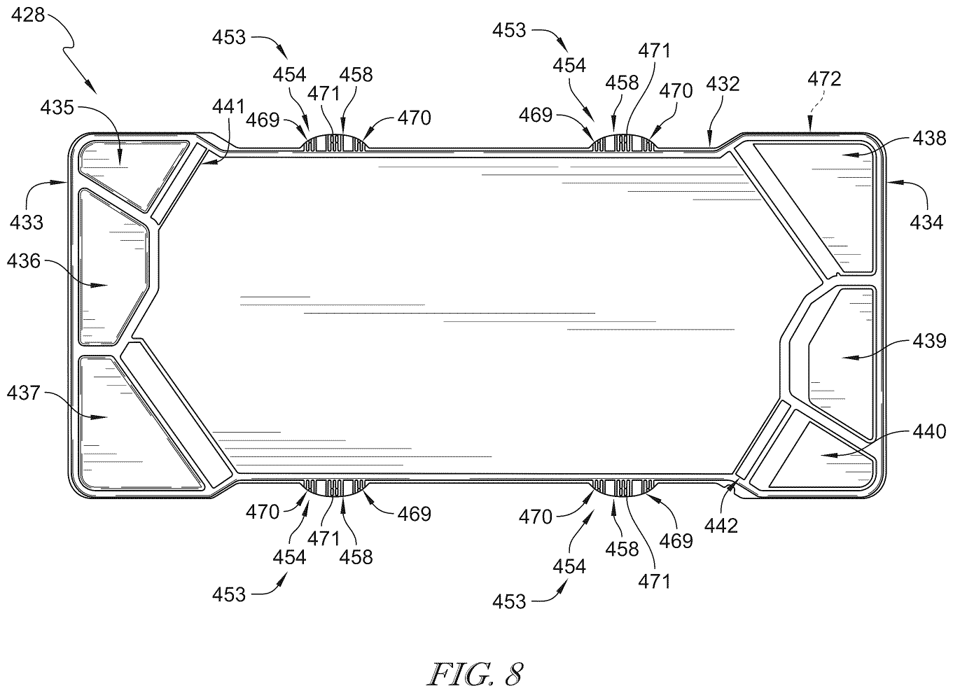

FIG. 8 shows a plurality of load-bearing extensions 453 each having a top extension body 454 and a bottom extension body (not shown). The load-bearing extensions 453 are formed similarly to the load-bearing extensions 153 described above. However, instead of having extension transverse edges, the load-bearing extensions 453 include a single, rounded second extension longitudinal edge 458. Moreover, the load-bearing extensions 453 may include the three groups of channels 469, 470, 471 similar to the channels 169, 170, 171 described above to provide additional mechanical strength to the load-bearing extension 453.

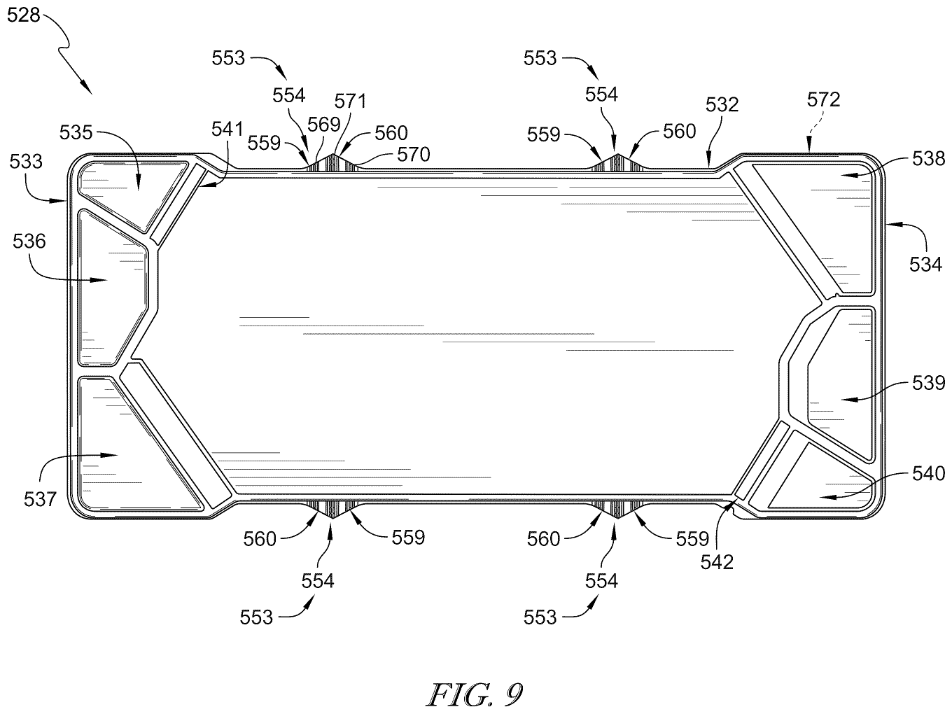

FIG. 9 shows a plurality of load-bearing extensions 553 each having a top extension body 554 and a bottom extension body (not shown). The load-bearing extensions 553 are formed similarly to the load-bearing extensions 153 described above. However, the extension transverse edges 559, 560 of the load-bearing extensions 553 are angled and converge at a single point. As such, the load-bearing extension 553 includes a triangular shape. Moreover, the load-bearing extensions 553 can include the three groups of channels 569, 570, 571 similar to the channels 169, 170, 171 described above to provide additional mechanical strength to the load-bearing extension 553.

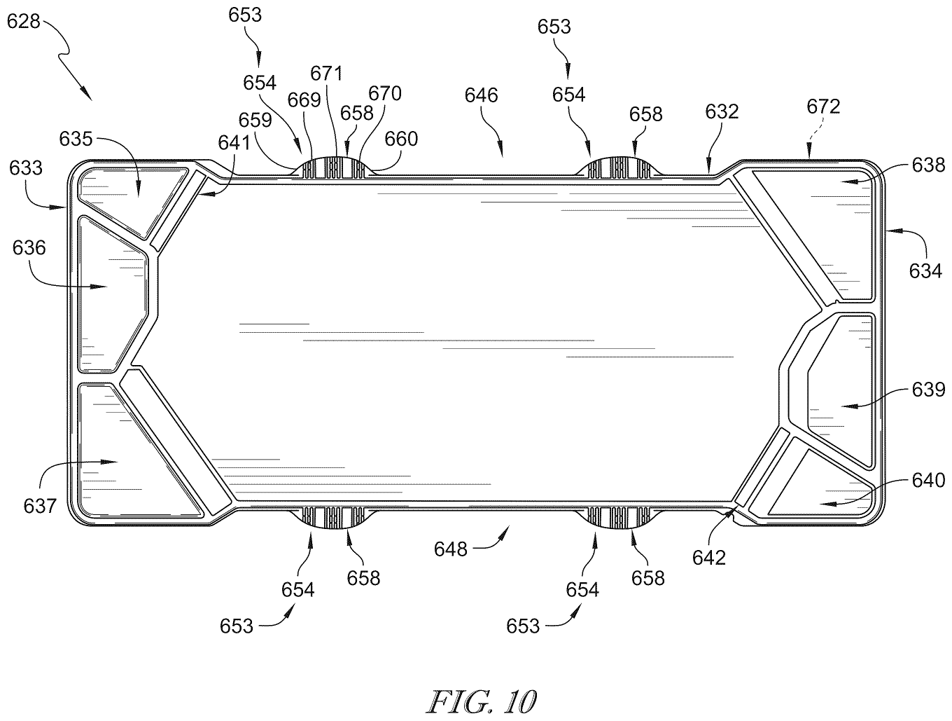

FIG. 10 shows a plurality of load-bearing extensions 653 each having a top extension body 654 and a bottom extension body (not shown). The load-bearing extensions 653 are formed similarly to the load-bearing extensions 153 described above. However, instead of having extension transverse edges, the load-bearing extensions 653 include a single, rounded second extension longitudinal edge 658 and rounded transition edges 659, 660 that connect to the edges 646, 648 of the bipolar plate 628. Moreover, the load-bearing extensions 653 may include the three groups of channels 669, 670, 671 similar to the channels 169, 170, 171 described above to provide additional mechanical strength to the load-bearing extension 653.

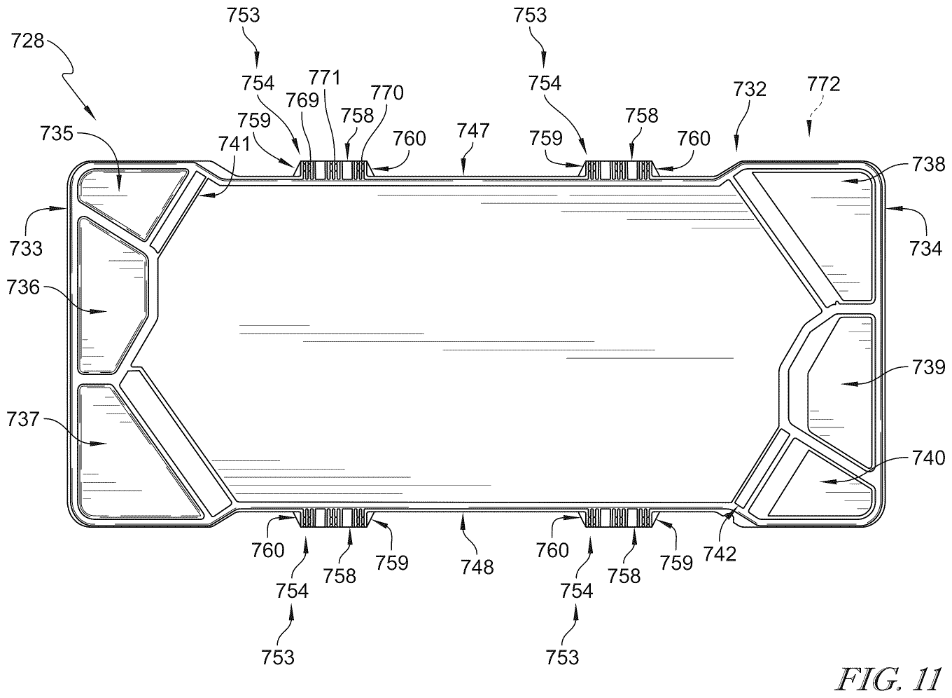

FIG. 11 shows a plurality of load-bearing extensions 753 each having a top extension body 754 and a bottom extension body (not shown). The load-bearing extensions 753 are formed similarly to the load-bearing extensions 153 described above. However, extension transverse edges 759, 760 of the load-bearing extensions 753 are angled and have a straight 758 extending between and interconnecting the transverse edges 759, 760. The straight 758 is parallel to the transverse edges 747, 748 of the bipolar plate 728. As such, the load-bearing extension 753 includes a trapezoidal shape. Moreover, the load-bearing extensions 753 may include the three groups of channels 769, 770, 771 similar to the channels 169, 170, 171 described above to provide additional mechanical strength to the load-bearing extension 753.

The semi-circular extensions 453, the triangular extensions 553, the curved extensions 653, and the trapezoidal extensions 753 provide additional surfaces for contacting the alignment bars 236 because there are contact surfaces provided by the outer edges 458, 559, 560, 658, 659, 660, 758, 759, 760 in two directions in the plane of the bipolar plate 428, 528, 628, 728.

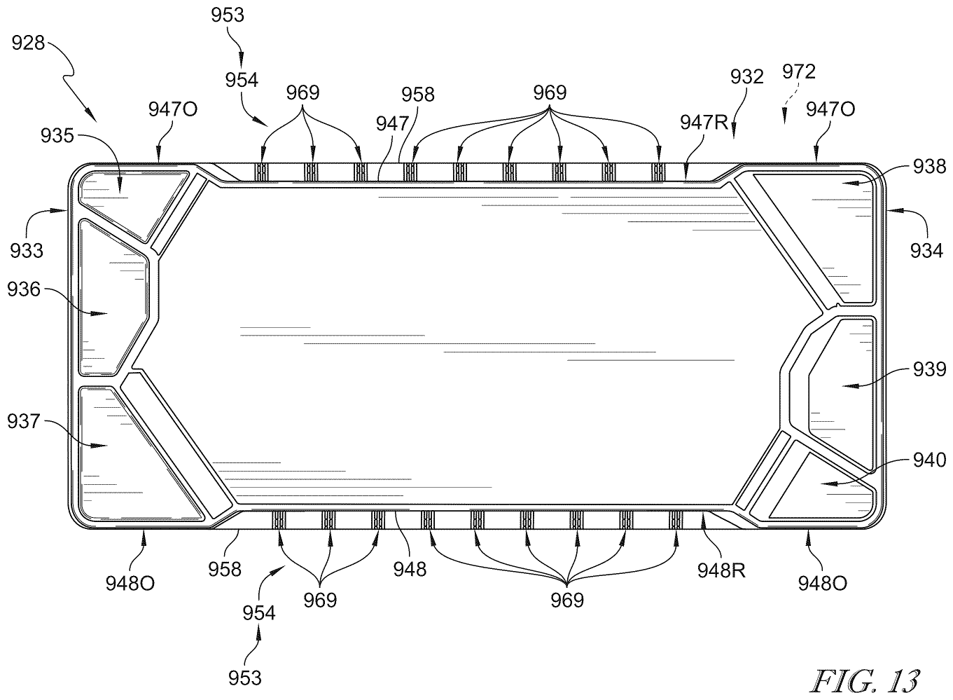

FIG. 12 shows a plurality of load-bearing extensions 853 each having a top extension body 854 and a bottom extension body (not shown). The load-bearing extensions 853 are formed similarly to the load-bearing extensions 153 described above. However, outer edges 847, 848, 887, 888 of each sheet 832, 872 are entirely straight across and do not include a recess 147R, 187R, 148R, 188R (as suggested in FIGS. 2 and 13). The load-bearing extensions 853 are arranged on the entirely straight outer edges 847, 887, 848, 888 of each sheet 832, 872.

FIG. 13 shows two load-bearing extensions 953 each having a top extension body 954 and a bottom extension body (not shown). Unlike the load-bearing extensions 153 described above, the load-bearing extensions 953 are formed to extend entirely across recessed portions 947R, 948R formed on each outer longitudinal edge 947, 948 of the sheet 932 (and a recessed portion of the bottom sheet 972, not shown). As such, an outer edge 958 of each load-bearing extension 953 is flush with an outermost portion 9470, 9480 of the outer edges 947, 948 of the sheet 932. Moreover, the load-bearing extensions 953 may include a plurality of channels 969 similar to the channels 169 described above to provide additional mechanical strength to the load-bearing extension 953.

Another embodiment of a bipolar plate 1028 is shown in FIGS. 14 and 15. The bipolar plate 1028 is similar to the bipolar plates 128, 328, 428, 528, 628, 728, 828, 928 shown in FIGS. 2-4 and 7-13, and described herein. Accordingly, similar reference numbers in the 1000 series indicate features that are common between the bipolar plate 1028 and the bipolar plates 128, 328, 428, 528, 628, 728, 828, 928. The descriptions of the bipolar plates 128, 328, 428, 528, 628, 728, 828, 928 are incorporated by reference to apply to the bipolar plate 1028, except in instances when they conflict with the specific description and the drawings of the bipolar plate 1028.

Similar to the bipolar plates 128, 328, 428, 528, 628, 728, 828, 928 described above, the bipolar plate 1028 includes a double sheet 1032, 1072 configuration, each sheet having similar manifold and active area arrangements. Unlike the bipolar plates 128, 328, 428, 528, 628, 728, 828, 928, the bipolar plate 1028, in addition or alternatively to the alignment bars 236 and/or the support bars 228, includes alignment through-holes 1052 formed through areas of the bipolar plate 1028 outside of an active area 1044, 1084. Corresponding alignment rods 250 arranged on the fuel cell stack assembling apparatus 212 may be inserted through the alignment through-holes 1052 during assembly and compression of the fuel cells 120 in the fuel cell stack assembling apparatus 212 in order to further maintain alignment of the fuel cell stack 112. The bipolar plate 1028 may include a single or multiple alignment through-holes 1052.

Similar to the load-bearing extensions 153, 353, 453, 553, 653, 753, 853, 953 described above, as shown in FIG. 15, the alignment through-holes 1052 may include load-bearing extensions 1053 therein, in particular top and bottom extension bodies 1054, 1094 (one extension body 1054 on the top side extending away from the top sheet 1032 and one extension body 1094 on the bottom side and extending away from the second sheet 1072, both extension bodies 1054, 1094 stacked together to form the load-bearing extension 1053). The extension bodies 1054, 1094 extend inwardly into the alignment through-hole 1052. Each of the extension bodies 1054, 1094 includes a flat surface 1056, 1096 and a radially inner edge 1058, 1098 that is configured to engage the corresponding alignment rod 250 and prevent deformation of the alignment through-holes 1052 during fuel cell stack 112 compression and assembly. In some embodiments, the extension bodies 1054, 1094 each include ridges 1069R, 1109R similar to the ridges 169R, 170R, 171R described above. Each ridge 1069R, 1109R defines a channel 1069, 1109 therein. In some embodiments in which both corresponding alignment rods 250 and alignment bars 236 are utilized, the bipolar plate 1028 may further include load-bearing extensions that extend away from the edges (see edges 146, 186 in FIG. 2) of the sheets 1032, 1072 similar to the load-bearing extensions 153 above.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments and aspects are described in sufficient detail to enable those skilled in the art to practice what is claimed and it is to be understood that other embodiments may be utilized and that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated.

Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps. The phrase “consisting of” or “consists of” refers to a compound, composition, formulation, or method that excludes the presence of any additional elements, components, or method steps.

The term “consisting of” also refers to a compound, composition, formulation, or method of the present disclosure that excludes the presence of any additional elements, components, or method steps. The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “generally,” “approximately,” “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise. In some embodiments, such approximating language may refer to any value within three percent of the indicated value.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell stack, comprising:
a first fuel cell including a first bipolar plate having a first bipolar plate sheet, the first bipolar plate sheet including:
a first outer sheet edge extending around a perimeter of the first bipolar plate sheet, the first outer sheet edge including a first longitudinal edge and a first transverse edge;
a first surface including a plurality of channels defining an active region of the first bipolar plate sheet, wherein the first longitudinal edge and the first transverse edge are located outside of the active region; and
a first load-bearing extension arranged on at least one of the first longitudinal edge or the first transverse edge of the first outer sheet edge, the first load-bearing extension configured to engage with an alignment bar or a support bar of a fuel cell stack assembling apparatus within which the fuel cell stack is compressed for assembly such that, during compression of the fuel cell stack, the first load-bearing extension engages the alignment bar or the support bar so as to transfer force loads from the alignment bar or the support bar away from the first outer sheet edge and toward a central area of the first bipolar plate sheet.

2. The fuel cell stack of claim 1, wherein the first bipolar plate sheet includes a first sheet body including the first outer sheet edge and the first surface, and wherein the first load-bearing extension is integrally formed with the first sheet body.

3. The fuel cell stack of claim 2, wherein the first load-bearing extension includes a generally planar top extension body having a first extension longitudinal edge that is adjoined to the first longitudinal edge or the first transverse edge of the first outer sheet edge of the first bipolar plate sheet.

4. The fuel cell stack of claim 3, wherein the top extension body of the first load-bearing extension further includes a first extension transverse edge and a second extension traverse edge spaced apart from and parallel with the first extension transverse edge, each of the first extension transverse edge and the second extension transverse edge extends away from the first extension longitudinal edge, and
wherein the top extension body of the first load-bearing extension further includes a second extension longitudinal edge spaced apart and parallel to the first extension longitudinal edge, and wherein the second extension longitudinal edge is configured to engage the alignment bar or the support bar.

5. The fuel cell stack of claim 4, wherein the first bipolar plate further includes a second bipolar plate sheet arranged on a second surface of the first bipolar plate sheet opposite the first surface, wherein the first load-bearing extension further includes a bottom extension body arranged on a bottom side of the top extension body and having a third extension longitudinal edge that is adjoined to a longitudinal edge of the second bipolar plate sheet, and wherein the top and bottom extension bodies are planar and together form the first load-bearing extension.

6. The fuel cell stack of claim 5, wherein the top extension body includes at least one top ridge formed thereon, wherein the bottom extension body includes at least one bottom ridge formed thereon, wherein the at least one top ridge and the at least one bottom ridge are raised in opposing directions so as to form a ridge channel between the at least one top ridge and the at least one bottom ridge, and wherein the at least one top ridge and the at least one bottom ridge each extend from the first extension longitudinal edge to the second extension longitudinal edge.

7. The fuel cell stack of claim 3, wherein the first bipolar plate sheet further includes a second load-bearing extension adjoined to the first sheet body on the first longitudinal edge or the first transverse edge and spaced apart from the first load-bearing extension.

8. The fuel cell stack of claim 3, wherein the first outer sheet edge of the first bipolar plate sheet further includes a second longitudinal edge opposite and parallel to the first longitudinal edge, and wherein the first bipolar plate sheet further includes a second load-bearing extension adjoined to the first sheet body on the second longitudinal edge.

9. The fuel cell stack of claim 3, further comprising:
a second fuel cell including a second bipolar plate having a second bipolar plate sheet, the second bipolar plate sheet including:
a second outer sheet edge extending around a perimeter of the second bipolar plate sheet, the second outer sheet edge including a third longitudinal edge and a third transverse edge;
a second surface including a plurality of channels defining an active region of the second bipolar plate sheet, wherein the third longitudinal edge and the third transverse edge are located outside of the active region; and
a second load-bearing extension arranged on at least one of the third longitudinal edge or the third transverse edge of the second outer sheet edge, the second load-bearing extension configured to engage with the alignment bar or the support bar of the fuel cell stack assembling apparatus such that, during compression of the fuel cell stack, the second load-bearing extension engages the alignment bar or the support bar so as to transfer force loads from the alignment bar or the support bar away from the second outer sheet edge and toward a central area of the second bipolar plate sheet,
wherein the second load-bearing extension is aligned with the first load-bearing extension of the first bipolar plate sheet such that engagement of the alignment bar or the support bar with the first and second load-bearing extensions aligns the first and second fuel cells with each other.

10. The fuel cell stack of claim 9, wherein the second load-bearing extension includes a generally planar top extension body having a third extension longitudinal edge that is adjoined to the third longitudinal edge of the second outer sheet edge of the second bipolar plate sheet, wherein the top extension body of the second load-bearing extension further includes a fourth extension longitudinal edge spaced apart and parallel to the third extension longitudinal edge, and wherein the fourth extension longitudinal edge of the second load-bearing extension is aligned with the second extension longitudinal edge of the first load-bearing extension.

11. A fuel cell stack assembly system, comprising:
a plurality of fuel cells including a first fuel cell including a first bipolar plate having a first bipolar plate sheet, the first bipolar plate sheet including a first outer sheet edge extending around a perimeter of the first bipolar plate sheet, a first surface, and a first load-bearing extension arranged on the first outer sheet edge; and
a fuel cell stack assembling apparatus including a stack-receiving space for receiving the plurality of fuel cells in a stacked arrangement so as to define a fuel cell stack, a press assembly configured to compress the plurality of fuel cells together, and at least one of an alignment bar or a support bar arranged outside of and adjacent to the plurality of fuel cells arranged in the stack-receiving space and configured to contact the plurality of fuel cells so as to maintain alignment of the plurality of fuel cells within the stack-receiving space,
wherein the first load-bearing extension is configured to engage with the alignment bar or the support bar of the fuel cell stack assembling apparatus such that, during compression of the fuel cell stack by the press assembly, the first load-bearing extension engages the alignment bar or the support bar so as to transfer force loads from the alignment bar or the support bar away from the first outer sheet edge and toward a central area of the first bipolar plate sheet and so as to maintain alignment of the plurality of fuel cells.

12. The fuel cell stack assembly system of claim 11, wherein the plurality of fuel cells further includes a second fuel cell including a second bipolar plate having a second bipolar plate sheet, the second bipolar plate sheet including a second outer sheet edge extending around a perimeter of the second bipolar plate sheet, a second surface, and a second load-bearing extension arranged on the second outer sheet edge, and wherein the second load-bearing extension is configured to engage with the alignment bar or the support bar of the fuel cell stack assembling apparatus such that, during compression of the fuel cell stack by the press assembly, the second load-bearing extension engages the alignment bar or the support bar so as to transfer force loads from the alignment bar or the support bar away from the second outer sheet edge and toward a central area of the second bipolar plate sheet.

13. The fuel cell stack assembly system of claim 12, wherein the second load-bearing extension of the second fuel cell is aligned with the first load-bearing extension of the first fuel cell in the stacked arrangement such that engagement of the alignment bar or the support bar with the first and second load-bearing extensions aligns the first and second fuel cells with each other.

14. The fuel cell stack assembly system of claim 11, wherein each fuel cell of the plurality of fuel cells includes a respective bipolar plate having a respective bipolar plate sheet, each respective bipolar plate sheet including a respective outer sheet edge extending around a perimeter of the respective bipolar plate sheet, a respective surface, and a respective load-bearing extension arranged on the respective outer sheet edge, wherein each of the respective load-bearing extensions is configured to engage with the alignment bar or the support bar of the fuel cell stack assembling apparatus such that, during compression of the fuel cell stack by the press assembly, each respective load-bearing extension engages the alignment bar or the support bar so as to transfer force loads from the alignment bar or the support bar away from each respective outer sheet edge and toward a central area of the respective bipolar plate sheet and so as to maintain alignment of the plurality of fuel cells.

15. The fuel cell stack assembly system of claim 11, wherein the first bipolar plate sheet includes a first sheet body including the first outer sheet edge and the first surface, and wherein the first load-bearing extension is integrally formed with the first sheet body.

16. The fuel cell stack assembly system of claim 15, wherein the first load-bearing extension includes a generally planar top extension body having a first extension longitudinal edge that is adjoined to the first longitudinal edge or the first transverse edge of the first outer sheet edge of the first bipolar plate sheet.

17. The fuel cell stack assembly system of claim 16, wherein the top extension body of the first load-bearing extension further includes a first extension transverse edge and a second extension traverse edge spaced apart from and parallel with the first extension transverse edge that each extend away from the first extension longitudinal edge, wherein the top extension body of the first load-bearing extension further includes a second extension longitudinal edge spaced apart and parallel to the first extension longitudinal edge, and wherein the second extension longitudinal edge is configured to engage the alignment bar or the support bar.

18. A method of forming a fuel cell stack, comprising:
arranging a plurality of fuel cells in a stacked arrangement within a stack-receiving space of a fuel cell stack assembling apparatus, each fuel cell of the plurality of fuel cells including a bipolar plate having a bipolar plate sheet, the bipolar plate sheet including an outer sheet edge extending around a perimeter of the bipolar plate sheet, a first surface, and a first load-bearing extension arranged on the outer sheet edge;
aligning each fuel cell of the plurality of fuel cells with each other via alignment of the outer sheet edges and the first load-bearing extensions of each fuel cell;
providing at least one of an alignment bar or a support bar outside of and adjacent to the plurality of fuel cells arranged in the stack-receiving space and configuring the at least one of the alignment bar or the support bar to contact at least one first load-bearing extension of a fuel cell of the plurality of fuel cells in order to maintain alignment of the plurality of fuel cells within the stack-receiving space; and
compressing each fuel cell of the plurality of fuel cells together via a press assembly of the fuel cell stack assembling apparatus such that the at least one first load-bearing extension engages with the alignment bar or the support bar of the fuel cell stack assembling apparatus so as to transfer force loads from the alignment bar or the support bar away from the outer sheet edges and toward a central area of the respective bipolar plate sheet and so as to maintain alignment of the plurality of fuel cells.

19. The method of claim 18, wherein the bipolar plate sheet of each fuel cell further includes a first through-hole extending through the bipolar plate sheet spaced apart from the outer sheet edge, the first through-hole including a further load-bearing extension extending inwardly from an inner circumferential edge of the first through-hole, the further load-bearing extension configured to engage with a further alignment rod of the fuel cell stack assembling apparatus such that, during compression of the fuel cell stack, the further load-bearing extension engages the further alignment rod so as to transfer force loads from the further alignment rod away from the inner circumferential edge of the first through-hole.

20. The method of claim 19, wherein the bipolar plate sheet of each fuel cell includes a first sheet body including the first through-hole, and wherein the further load-bearing extension is integrally formed with the first sheet body.
